(19) United States
(12) Patent Application Publication
(10) Pub. No.: US 2013/0323555 A1
(43) Pub. Date: Dec. 5, 2013

(54) LITHIUM-ION RECHARGEABLE BATTERY ANODE, LITHIUM-ION RECHARGEABLE BATTERY UTILIZING THE LITHIUM-ION RECHARGEABLE BATTERY ANODE, AND MANUFACTURING METHOD THEREOF

(71) Applicant: Hitachi, Ltd., Tokyo (JP)

(72) Inventor: Takaaki SUZUKI, Kasama (JP)

(21) Appl. No.: 13/909,356

(22) Filed: Jun. 4, 2013

(30) Foreign Application Priority Data
Jun. 4, 2012 (JP) 2012-126674

(51) Int. Cl. H01M 10/04

(52) U.S. Cl. CPC H01M 10/0431
USPC 429/94; 429/211; 427/58

(57) ABSTRACT

A lithium-ion rechargeable battery, and an anode for a lithium-ion rechargeable battery containing an anode mix layer including a high density anode mix layer formed over an anode current collector, and a low density anode mix layer formed over the high density anode mix layer; and in which the electrode density of the high density anode mix layer is larger than the electrode density of the low density anode mix layer, the upper surface and the side surfaces of the high density anode mix layer are covered by the low density anode mix layer; and the film thickness of the high density anode mix layer is 50 percent or less than the film thickness of the anode mix layer.

### TECHNICAL FIELD

The present invention relates to a lithium-ion rechargeable battery anode, a lithium-ion rechargeable battery, and a manufacturing method for the lithium-ion rechargeable battery anode and the lithium-ion rechargeable battery.

### BACKGROUND

In recent years intensive efforts have been made in developing lithium-ion rechargeable batteries. The patent document 1 through patent document 4 (Unexamined Patent Application Publication No. 2011-204491, No. 2011-204490, No. 2011-204489, 2011-204488) disclose technology for an electrode active material layer including a fine layer positioned on the current collector side, and an air-gap forming layer positioned on the upper surface of the fine layer so that an electrolyte solution permeates satisfactorily into the air-gap layer, allowing smooth movement of lithium ions, and the presence of the fine layer between the air-gap forming layer and current collector allows excellent conduction of electrons between the current collector and active material.

### SUMMARY

In patent document 1 through patent document 4 (Unexamined Patent Application Publication No. 2011-204491, No. 2011-204490, No. 2011-204489, 2011-204488) the shape of the fine layer and the air-gap forming layer are not known so that the electrolyte solution might not adequately permeate into the fine layer so that high inflow and outflow characteristics to the lithium-ion rechargeable battery might prove unsatisfactory. The present invention therefore has the object of improving inflow and outflow characteristics to the lithium-ion rechargeable battery.

Features of the present invention to resolve the aforementioned issues are described as follows. An anode for a lithium-ion rechargeable battery containing an anode mix layer including a high density anode mix layer formed over a anode current collector, and a low density anode mix layer formed over a high density anode mix layer; and in which the electrode density of the high density anode mix layer is larger than the electrode density of the low density anode mix layer, the upper and side surfaces of the high density anode mix layer are covered by the low density anode mix layer.

In the above lithium-ion rechargeable battery anode, the film thickness of the high density anode mix layer is 50% or less than the film thickness of the anode mix layer.

In the above lithium-ion rechargeable battery anode, the high density anode mix layer is formed in a line shape over the anode current collector.

In the above lithium-ion rechargeable battery anode, the composition of the high density anode mix layer and the composition of the low density anode mix layer are the same.

In the above lithium-ion rechargeable battery anode, the percentage occupied by the width of the high density anode mix layer is 60% or less than the width of the anode mix layer.

In the above lithium-ion rechargeable battery anode, the conducting agent is added to the high density anode mix layer, and the conducting agent is not added to the low density anode mix layer.

In the above lithium-ion rechargeable battery anode, the anode current collector and the anode mix layer are wound; and the high density anode mix layer is formed in a line shape, and perpendicular to the wound direction of the lithium-ion rechargeable battery anode.

In the above lithium-ion rechargeable battery anode, the anode current collector and the anode mix layer are wound; and the high density anode mix layer is formed in a line shape parallel to the wound direction of the lithium-ion rechargeable battery anode, and the high density anode mix layer is formed only over the edge in the width direction of the anode mix layer.

The lithium-ion rechargeable battery is comprised of the above lithium-ion rechargeable battery anode, a lithium-ion rechargeable battery cathode, and an organic electrolyte solution in which the lithium-ion rechargeable battery cathode and the lithium-ion rechargeable battery anode are submerged.

A manufacturing method for a lithium-ion rechargeable battery anode containing a high density anode mix layer formed over the anode current collector, and a low density anode mix layer formed over the high density anode mix layer; and in which the electrode density of the high density anode mix layer is larger than the electrode density of the low density anode mix layer, the upper and side surfaces of the high density anode mix layer are covered by the low density anode mix layer, and a process to form a high density anode mix layer over the anode current collector, and a process to form a low density anode mix layer so as to cover the upper and side surfaces of the high density anode mix layer after the high density anode mix layer was formed.

The present invention is capable of improving the required inflow and outflow characteristics of the lithium-ion rechargeable battery. Issues, structures, and effects other than described above are clarified in the following description of the examples.

### BRIEF DESCRIPTION OF THE DRAWINGS

FIG. 1 is a one-sided longitudinal cross sectional view showing the entire structure of an embodiment of the rechargeable battery utilizing the lithium-ion rechargeable battery electrode of the present invention;

FIG. 2 is a cross sectional view showing the structure of the embodiment of the present invention;

FIG. 3 is a cross sectional view showing the structure of the embodiment of the present invention;

FIG. 4 is a perspective view showing a layout model drawing of the structure of the embodiment of the present invention;

FIG. 5 is a perspective view showing a layout model drawing of the structure of the embodiment of the present invention;

FIG. 6 is a perspective view showing a layout model drawing of the structure of the embodiment of the present invention; and

FIG. 7 is a perspective view showing a layout model drawing of the structure of the embodiment of the present invention.

### DETAILED DESCRIPTION

The embodiments of the present invention are described next while referring to the accompanying drawings. In the following description, working examples are utilized to show the content of the present invention. However, the present invention is not limited by this description and various changes and corrections are allowable within the range of the technical concepts disclosed in the specifications for the present invention. Moreover, the same reference numerals are attached to items having the same functions in all the drawings for describing the present invention and a repetitive description is omitted in some cases.

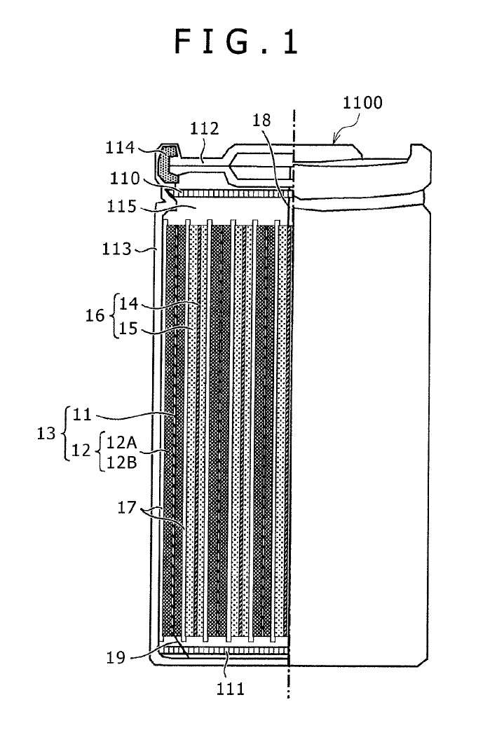

FIG. 1 is a drawing showing the entire structure of the embodiment of the rechargeable battery utilizing the lithium-ion rechargeable battery electrode of the present invention.

A lithium-ion rechargeable battery 1100 is broadly comprised of a cathode 16 and an anode 13 to reversibly absorb and discharge lithium ions, a separator 17 mounted interposed between the cathode 16 and the anode 13, an organic electrolyte solution 115 to dissolve the electrolyte containing the lithium ions. The cathode 16, the anode 13, the separator 17 are wound into a wound set. The cathode 16 is here roughly comprised of a cathode current collector 14 and a cathode mix layer 15 mounted over both surfaces of the cathode current collector 14, and one end of a cathode lead 18 is welded to the cathode current collector 14 to gather the concentrated electrons from the cathode 16. The anode 13 is roughly comprised of a anode current collector 11 and a anode mix layer 12 mounted over both surfaces of the anode current collector 11, and one end of the anode lead 19 is welded to the anode current collector 11 to gather the concentrated electrons from the anode 13. In FIG. 1, the reference numeral 110 denotes a cathode insulator, the reference numeral 111 denotes an anode insulator, and the reference numeral 114 denotes a gasket.

Other than the wound cylindrical shape as shown in FIG. 1, the shape of the battery may be selected from among any of a flat elliptical shape, a wound squared shape, and a stacked layered shape, etc. A lithium-ion rechargeable battery having a stacked layer of alternately arranged plural cathode plates, and plural anode plates with separators interposed between them is also applicable to the invention.

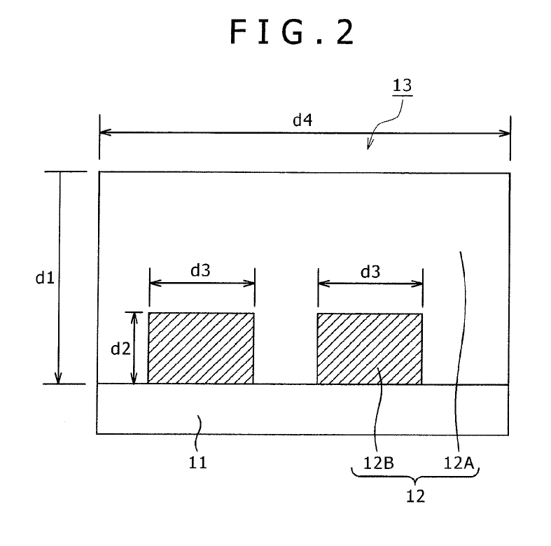

The lithium-ion rechargeable battery anode of the embodiment of the present invention is described next while referring to FIG. 2. The drawing in FIG. 2 shows the basic structure of the lithium-ion rechargeable battery anode of the embodiment of the present invention. The anode 13 for the lithium-ion rechargeable battery shown in FIG. 2 contains the anode mix layer 12 mounted over one surface of the anode current collector 11 but the anode mix layers 12 may be mounted over both surfaces of the anode current collector 11 as shown in FIG. 11.

The anode mix layer 12 includes a high density anode mix layer 12B, and a low density anode mix layer 12A. The electrode density (g/cm³) of the high density anode mix layer 12B is larger than the electrode density of the low density anode mix layer 12A. In the example 1 of the present invention, the permeability of the electrolyte solution is improved by forming the high density anode mix layer 12B over the anode current collector 11 and forming the low density anode mix layer 12A so as to cover the upper and side surfaces of the high density anode mix layer 12B. The low density anode mix layer 12A contains a suitable air-gap so that the electrolyte solution can permeate through this air-gap to the high density anode mix layer 12B and anode current collector 11.

The battery using the low density anode mix layer tends to exhibit cycle characteristics superior to batteries using a high density anode mix layer. The cycle life characteristics can therefore be improved by a structure such as the embodiment of the present invention in which the high density anode mix layer 12B and the negative current collector 11 are covered by the low density anode mix layer 12A.

The high density anode mix layer 12B on the other hand can improve the sealing between the negative current collector 11 and the anode mix layer 12. The theory is described while referring to FIG. 2.

In the embodiment of the present invention, the high density anode mix layer 12B containing natural graphite is formed over the current collector 11. A feature of the example is that the high density anode mix layer 12B is at this time formed in a line shape along the length of the electrode. Forming the high density anode mix layer 12B in a line shape boosts the introduction of electrolyte solution into the high density anode mix layer 12B. Forming the high density anode mix layer 12B in a line shape also allows utilizing the upper surface and side surface of the high density anode mix layer 12B so that a larger surface area is obtained. An ample electrolyte solution can therefore be supplied to the high density anode mix layer 12B. Moreover, mounting the high density anode mix layer 12B also provides the effect of enhancing the sealing of the anode mix layer 12 to the anode current collector 11.

Increasing the electrode density of the high density anode mix layer 12B to larger than that of the low density anode mix layer 12A allows easily obtaining conductivity compared to the case for example where varying the quantity of the binder in two anode mix layers. Increasing the binder quantity for example increases the resistance of the anode mix layer 12. This higher resistance may lead to a high resistance within the overall battery utilizing the anode mix layer 12.

In the embodiment of the present invention, press forming is utilized to boost the electrode density of the high density anode mix layer 12B. Press forming is a technique to enhance the sealing between the anode mix layer 12 and the anode current collector 11 by applying a strong force along the film thickness direction rather than low density anode mix layer 12A by methods such as pressing plural times to achieve a thin material or narrowing the processing gap more than that of the low density anode mix layer 12A.

The high density anode mix layer 12B renders the effect of reinforcing the sealing of the low density anode mix layer 12A. The anchor effect from the high density anode mix layer 12B enhances the sealing effect with the low density anode mix layer 12A. The overall strength of the anode mix layer 12 is consequently improved.

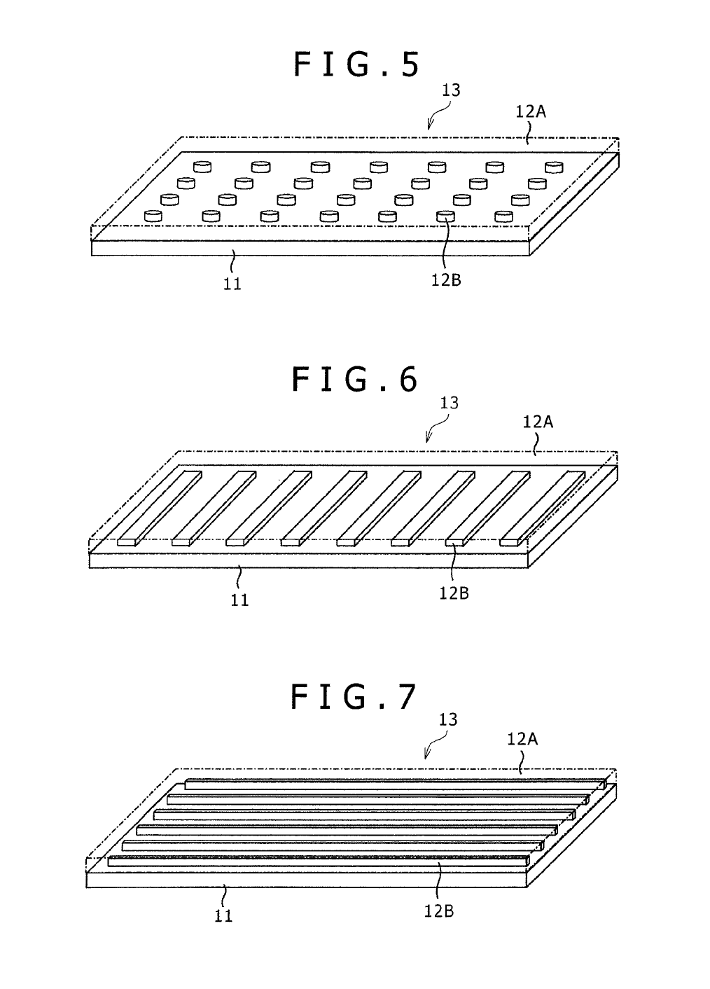

Mounting the high density anode mix layer 12B in a line shape allow renders the effect of securing a conduction path between the high density anode mix layer 12B and the anode current collector 11. The same effect as the line shape can also be obtained by forming the high density anode mix layer 12B in dot shapes or staggered shapes as shown in FIG. 5. Compared to forming a line shapes, forming dot shapes as shown in FIG. 5 lowers the amount of slurry used for the anode mix layer 12 and random positioning is simple. In the forming of the high density anode mix layer 12B, the high density anode mix layer 12B may be formed parallel to the wound direction of the wound set as shown in FIG. 4, and may be formed perpendicular to the wound direction of the wound set as shown in FIG. 6. Forming the high density anode mix layer 12B in a direction perpendicular to the wound direction of the wound set makes the winding easier, and also reinforces the cavity in the center section of the wound set to provide greater strength. There is no need to form the shape in a strictly perpendicular direction when forming the high density anode mix layer 12B, and a high density anode mix layer 12B having a certain amount of tilt in the wound direction of the wound set is allowable.

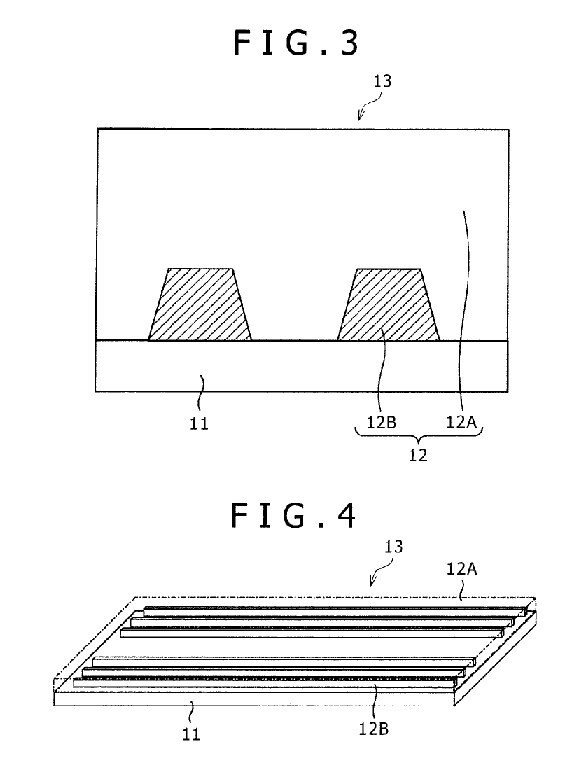

The cross sectional shape of the high density anode mix layer 12B in FIG. 2 is a rectangular shape however a trapezoidal shape for the high density anode mix layer 12B cross section as shown in FIG. 3 is also permissible. Forming a high density anode mix layer 12B as shown in FIG. 3 increases the area on the side surfaces and promotes permeability of the electrolytic solution more than the rectangular shape.

The film thickness of the high density anode mix layer 12B (d2 in FIG. 2) is 50% or less than the total film thickness of the anode mix layer 12 (d1 in FIG. 2) and more preferably is 30% or less than the total film thickness. A thickness greater than 50% may cause irregularities (cavities/protrusions) on the surface of the anode mix layer 12.

The percentage occupied by the width of the high density anode mix layer 12B (d3 in FIG. 2) is 60% or less the width of the anode mix layer 12 (d4 in FIG. 2) and preferably is 40% or less than the width. If this percentage is 60% or more then the conduction path between the low density anode mix layer 12A and the anode current collector 11 may be inadequate.

The high density anode mix layer 12B may be mounted along the entire width of the anode mix layer 12 as shown in FIG. 7, however is mounted over both edges along the width shown in FIG. 4, or is more preferably mounted only over both edges along the width. Mounting the high density anode mix layer 12B over both edges along the width of the anode mix layer 12 to match the deformation of the wound set that occurs due to repeated charging and discharging will prove effective though some variation will occur due to the composition of the wound set and the anode active material, etc.

The high density anode mix layer 12B and the low density anode mix layer 12A are layers of different densities and those densities will vary according to the active material. In the case of natural graphite for example, the density of the low density anode mix layer 12A is preferably between 1.0 to 1.5 g/cm³. A density that is lower than 1.0 g/cm³ will make the anode mix layer 12 brittle. The density of the high density anode mix layer 12B on the other hand is larger than the low density anode mix layer 12A and there are no particular restrictions as long as the density allows securing a suitable air-gap however the density is preferably in the range higher than 1.5 g/cm³ and equal to or lower than 2.0 g/cm³. The electrode density of the high density anode mix layer 12B/low density anode mix layer 12A is preferably 1.1 or higher and 2.0 or lower.

The low density anode mix layer 12A and the high density anode mix layer 12B are comprised of anode active material, conducting agent, and binder resin. Adding the conducting agent renders the effect of lowering the resistance. Utilizing a composition for the low density anode mix layer 12A and an identical composition for the high density anode mix layer 12B (setting the same ingredient and the same content in each mix layer) serves to lower the production cost during press forming and so on by utilizing the same conditions and a common slurry for the coating.

The anode active material utilized in the embodiment of the present invention may include graphite-based material such as natural graphite or artificial graphite. Moreover, natural graphite subjected to various surface treatments by the dry-type CVD (chemical vapor deposition) method or moist type spray method and so on, artificial graphite manufactured by firing using resin material such as epoxy or phenol or pitch type material obtained from oil or coal as the raw material, silicon (Si), graphite mixed silicon, or non-graphitizing carbon materials may also be utilized. When the anode active material contained in the high density anode mix layer 12B is set as high density anode active material, and the anode active material contained in the low density anode mix layer 12A is set as low density anode material, this high density anode active material and low density anode active material can also utilize the same types or different types among the above described materials.

A conducting agent may be further added to reduce the electron resistance in the high density anode mix layer 12B and the low density anode mix layer 12A. Here, carbon material for example such as carbon black, graphite, carbon fiber, and metal carbides may be utilized as the conducting agent, or each ingredient may be utilized separately or utilized by mixing. In the example 1 of the present invention, the conductance can be easily assured by adding conducting agent to the high density anode mix layer 12B even if conducting agent is not added to the low density anode mix layer 12A. The low density anode mix layer 12A contains many air-gaps compared to the high density anode mix layer 12B. The conductance is therefore easily ensured since the electrolyte solution permeates adequately. There is however no problem whatsoever with adding conducting agent to the low density anode mix layer 12A as required, and conducting agent may be added according to the active material utilized in particular in the low density anode mix layer 12A.

The cathode active material utilized in the embodiment of the present invention may include: LiCoO₂, LiNiO₂, LiMn₂O₄ for general use, and others may include LiMnO₃, LiMn₂O₃, LiMnO₂, Li₄Mn₅O₁₂, LiMn₂₋ₓMₓO₂ (however, M=Co, Ni, Fe, Cr, Zn, Ta, in which x=0.01 through 0.2), Li₂Mn₃MO₈ (however, M=Fe, Co, Ni, Cu, Zn), Li₁₋ₓAₓMn₂O₄ (however, A=mg, B, Al, Fe, Co, Ni, Cr, Zn, Ca, in which x=0.01 through 0.1), LiNi₁₋ₓMₓO₂ (however, M=Co, Fe, Ga, in which x=0.01 through 0.2), LiFeO₂, Fe₂(SO₄)₃, LiCo₁₋ₓMₓ.O₂ (however, M=Ni, Fe, Mn, in which x=0.01 through 0.2), LiNi₁₋ₓMₓO₂ (however, M=Mn, Fe, Co, Al, Ga, Ca, Mg, in which x=0.01 through 0.2), Fe (MoO₄)₃, FeF₃, LiFePO₄, LiMnPO₄, etc.

There are no particular restrictions on the type of binder utilized in the high density anode mix layer 12B, the low density anode mix layer 12A, and the cathode mix layer, and binders generally utilized for fabricating electrodes in lithium-ion batteries may be used. For example one or more types in any of macromolecular materials such as polyVinylidene DiFluoride (PVDF), polytetrafluoroethylene (PTFE), or polyvinylpyridine may be used. Moreover, one or more types in any of aqueous binders capable of utilizing water as diluted solution, represented by styrene-butadiene rubber and so on may be utilized in combinations with carboxymethylcellulose (CMC) serving as a thickener. When the binder contained in the high density anode mix layer 12B is a high density anode binder, and the anode binder contained in the low density anode mix layer 12A is a low density anode binder in the present invention, the high density anode binder and the low density anode binder may utilize the same types or different types from the above described materials.

The separator used in the embodiment of the present invention may be a separator utilized in the lithium-ion batteries of the known art. Representative materials may include non-woven cloth and porous polyolefin film such as polyethylene, polyprophylene, etc. The separator thickness is preferably 30 um or less from the standpoint of large battery capacity and more preferably is 18 um or less.

Representative examples of electrolyte solution usable in the embodiment of the present invention are a liquid solution of lithium hexafluorophosphate (LiPF₆) or lithium tetrafluoroborate (LiBF₄) as the electrolyte solution dissolved into a mixed solvent of dimethyl carbonate, diethyl carbonate, or ethyl methyl carbonate and so on mixed into ethylene carbonate. The present invention is not limited by the above types of solvent or electrolyte, or the solvent mix ratio, and other electrolytic solutions may be utilized.

Representative examples utilizable in the electrolytic solution are non-aqueous solvents such as propylene carbonate, ethylene carbonate, buthylene carbonate, vinylene carbonate, gamma-butyrolactone, dimethyl methyl carbonate, diethyl carbonate, methyl ethyl carbonate, 1,2-dimethoxyethane, 2-Methyltetrahydrofuran, dimethyl sulfoxide, 1,3-dioxolane, formamide, dimethylformamide, propanoic acid methyl, propanoic acid ethyl, triphenyl phosphate, trimethoxymethane, dioxolane, diethyl ether, sulfolane, 3-methyl-2-oxazolidinones, tetrahydrofuran, 1,2-diethoxyethane, chloroethylene carbonate, and chloropropylene carbonate, etc. Solvents other than above may also be utilized if not decomposed by the cathode 16 or the anode 13 internally within the battery of the present invention.

Representative examples utilizable in the electrolyte are LiPF₆, LiBF₄, or LiClO₄, LiCF₃SO₃, LiCF₃CO₂, LiAsF_{G}, LiSbF₆ or plural types of lithium salts such as imide salts of lithium typified by lithium bis(trifluoromethanesulfonyl)imide. A non-aqueous electrolyte solution by which these salts are dissolved into the above solvents can be utilized as the battery electrolyte solution. Electrolyte solutions other than the above may be utilized if not decomposed by the cathode 16 or the anode 13 contained within the battery of the present invention.

### Example 1

### <Fabricating the Anode>

The fabrication of the anode is described next while referring to FIG. 1, FIG. 2, and FIG. 4.

The high density anode mix layer 12B was formed over the copper foil of the anode current collector 11. More specifically, natural graphite was utilized as the anode active material of the high density anode mix layer 12B, styrene-butadiene rubber (SBR) was utilized as the binder, and carboxymethylcellulose (CMC) was utilized as the thickener in equal proportions with the SBR. The graphite and binder were kneaded in a mix ratio of 98.0:2.0, and the anode mix slurry was adjusted by adding water to change the viscosity. This adjusted anode mix slurry was then coated over the anode copper foil current collector 11 with a thickness of 10 μm, and after drying in warm air at 110° C., the same anode mix slurry was coated over the backside surface to form the high density anode mix layer 12B. In this coating, the high density anode mix layer 12B was formed in a line shape utilizing the inkjet method. Press forming was performed by roll milling to adjust the film thickness of one side of the high density anode mix layer 12B to 19 μm. The electrode density of the high density anode mix layer 12B was 1.8 g/cm³.

The low density anode mix layer 12A was next formed over the high density anode mix layer 12B. The anode active material of the low density anode mix layer 12A utilized the same material as the high density anode mix layer 12B. The natural graphite and the styrene-butadiene rubber (SBR) utilized as the binder, and the carboxymethylcellulose (CMC) serving as the thickener were utilized in equivalent amounts to the SBR. The graphite and binder were kneaded in a mix ratio of 98.0:2.0, and the anode mix slurry was adjusted by adding water to change the viscosity. This adjusted anode mix slurry was then coated over the high density anode mix layer 12B and after drying in warm air at 110° C., the same anode mix slurry was coated over the backside surface and dried. Press forming was performed by roll milling to adjust the film thickness of one side of the anode mix layer 12 to 57 pm to fabricate the anode 13. The electrode density of the low density anode mix layer 12A was 1.4 g/cm³.

### <Cathode>

The material LiMn_{1/3}Ni_{1/3}Co_{1/3}O₂ is utilized as the cathode active material. A dried mix of carbon black (CB1) and graphite (GF2) is utilized as the cathode active material and the electron conducting material. The polyVinylidene DiFluoride (PVDF) serving as the mix material and binder and to which N-methylpyrrolidone (NMP) was added as a solvent was mixed as the adjusted cathode mix slurry. Ingredients were apportioned so that solid ratio when this material was dried was LiMn_{1/3}Ni_{1/3}CO_{1/3}O₂:CB1:GF2:PVDF=86:9:2:3. The cathode mix slurry was next coated over both surfaces of the cathode current collector 14 comprised of aluminum foil with a 15 μm film thickness, and after drying at 120° C., was press-processed by roll milling to fabricate the cathode 16.

### <Winding and Assembly>

Porous polyethylene film was utilized as the separator 17 of the present example. Moreover, the electrolyte solution 115 (organic electrolyte solution) was produced by preparing ethylene carbonate (EC), vinylene carbonate (VC), dimethyl carbonate (DMC), ethyl methyl carbonate (EMC), and the solvent mixed so as to obtain a volumetric composition ratio of EC:VC:DMC:EMC=19.8:0.2:40:40, and 1M dissolved using LiPF₆ as the lithium salt serving as the solute.

A separator 17 was interposed between the anode 13 and cathode 16 fabricated using the above fabrication method, to form a wound set and inserted into the battery can 113 serving as the anode. Along with welding one end of the nickel (Ni) anode lead 19 for current collection at the anode 13, the other end of the nickel (Ni) anode lead 19 is welded to the battery can 113. Further, along with welding one end of the aluminum (Al) cathode lead 18 to the cathode current collector 14 for current collection at the cathode 16, the other end is welded and electrically connected to the battery lid 112 serving as the cathode by way of a current breaker (not shown in drawing). The electrolyte solution 115 was injected inside the battery can 113 and the cathode 16, anode 13, and separator 17 were submerged into the electrolyte solution 115 and the discharge opening of the battery can 113 sealed by way of a caulking machine to in this way fabricate the lithium-ion rechargeable battery 1100.

### Example 2

The wound type battery of the present example was fabricated as described in FIG. 1, FIG. 2 and FIG. 5. Other than the anode 13, the wound type lithium-ion rechargeable battery 1100 was fabricated the same as in the example 1.

### <Fabricating the Anode>

The high density anode mix layer 12B was formed over the copper foil of the anode current collector 11. More specifically, natural graphite was utilized as the anode active material, styrene-butadiene rubber (SBR) was utilized as the binder, and carboxymethylcellulose (CMC) was utilized as the thickener in equal proportions with the SBR. The graphite and binder were kneaded in a mix ratio of 98.0:2.0, and the anode mix slurry was adjusted by adding water to change the viscosity. This adjusted anode mix slurry was then coated over the copper foil of the anode current collector 11 with a thickness of 10 μm, and after drying in warm air at 110° C., the same anode mix slurry was also coated over the backside surface to form the high density anode mix layer 12B. In the coating in this example, the high density anode mix layer 12B was formed in a dot shape utilizing the inkjet method. Press forming was performed by roll milling to adjust the film thickness of one side of the high density anode mix layer 12B to 15 μm. The electrode density of the high density anode mix layer 123 was 1.7 g/cm³.

The low density anode mix layer 12A was next formed over the high density anode mix layer 12B. The anode active material of the low density anode mix layer 12A utilized the same material (composition) as the high density anode mix layer 12B. The natural graphite and the styrene-butadiene rubber (SBR) serving as the binder, and the carboxymethylcellulose (CMC) serving as the thickener, were utilized in equivalent amounts to the SBR. The graphite and binder were kneaded in a mix ratio of 98.0:2.0, and the anode mix slurry was adjusted by adding water to change the viscosity. This adjusted anode mix slurry was then coated over the high density anode mix layer 12B and after drying in warm air at 110° C., the same anode mix slurry was also coated over the backside surface and dried. Press forming was performed by roll milling to adjust the film thickness of one side of the anode mix layer 12 to 60 μm to fabricate the anode 13. The electrode density of the low density anode mix layer 12A was 1.2 g/cm³.

### Example 3

The wound type battery of the present example was fabricated as described in FIG. 1, FIG. 3 and FIG. 6. Other than the high density anode mix layer 12B, the wound type lithium-ion rechargeable battery 1100 was fabricated in the same way as in the example 1.

### <Fabricating the Anode>

The high density anode mix layer 12B was formed over the copper foil of the anode current collector 11. More specifically, natural graphite was utilized as the anode active material, styrene-butadiene rubber (SBR) was utilized as the binder, and carboxymethylcellulose (CMC) was utilized as the thickener in equal proportions with the SBR. The graphite and binder were kneaded in a mix ratio of 98.0:2.0, and the anode mix slurry was adjusted by adding water to change the viscosity. This adjusted anode mix slurry was then coated over the copper foil of the anode current collector 11 with a thickness of 10 pm, and after drying in warm air at 110° C., the same anode mix slurry was also coated over the backside surface to form the anode mix layer 12. In the coating, the line shape of the mix layer was formed along the width direction (perpendicular to length) of the anode current collector in a printing method utilizing a mask having a line shape. Press forming was performed by roll milling to adjust the film thickness of one side of the high density anode mix layer 12B to 20 μm (electrode density of 1.9 g/cm³).

### Example 4

The wound type battery of the present example was fabricated as described in FIG. 1, FIG. 2 and FIG. 4. Other than the high density anode mix layer 12B, the wound type lithium-ion rechargeable battery 1100 was fabricated in the same way as in the example 1.

### <Fabricating the Anode>

The high density anode mix layer 12B was formed over the copper foil of the anode current collector 11. More specifically, natural graphite was utilized as the anode active material, styrene-butadiene rubber (SBR) was utilized as the binder, and carboxymethylcellulose (CMC) was utilized as the thickener in equal proportions with the SBR. The graphite and binder, also carbon black were kneaded in a mix ratio of 96.0:2.0:2.0, and the anode mix slurry was adjusted by adding water to change the viscosity. This adjusted anode mix slurry was then coated over the copper foil of the anode current collector 11 with a thickness of 10 μm, and after drying in warm air at 110° C., the same anode mix slurry was also coated over the backside surface to form the anode mix layer 12. The inkjet method was utilized in the coating. Stripe shapes were formed in a pattern in the same way as in FIG. 2 and FIG. 4. Press forming was performed by roll milling to adjust the film thickness of one side of the high density anode mix layer 12B to 30 μm (density of 1.7 g/cm³).

### Comparative Example 1

A comparative example 1 is an anode mix layer 12 that has a single layer structure utilizing natural graphite. The density of the anode mix layer 12 was adjusted to attain 2.0 g/cm³. The manufacturing method for the anode 13 was the same as the manufacturing method for the high density anode mix layer 12B of the example 1. Other than the anode 13, the wound type lithium-ion rechargeable battery 1100 was fabricated in the same way as in the example 1.

### Comparative Example 2

A comparative example 2 is an anode mix layer 12 that has a single layer structure utilizing natural graphite. The density of the anode mix layer 12 was adjusted to attain 0.9 g/cm³. The manufacturing method for the anode 13 was the same as the manufacturing method for the low density anode mix layer 12A of the example 1. Other than the anode 13, the wound type lithium-ion rechargeable battery 1100 was fabricated in the same way as in the example 1.

### <Verification>

The wound type lithium-ion rechargeable battery of the examples 1 through 4 and the comparative examples 1 and 2 manufactured by the above described manufacturing methods were evaluated for cycle characteristics (life characteristics) by utilizing cycle tests. Conditions for the cycle (life) test were: charging the rechargeable battery to 4.1 volts at a charging current of 1C (coulomb), charging to a fixed voltage of 4.2 volts and after stopping operation for 15 minutes, discharging to 3.0 volts at a discharge current of 3C, and then stopping operation for 15 minutes. This charging and discharging was performed for 500 cycles and the capacitive change in the rechargeable battery before and after the cycle test was verified.

Table 1 shows the results of the cycle tests wound type lithium-ion rechargeable battery of the examples 1 through 4 and the comparative examples 1 and 2.

TABLE 1

| | | | | | | | | Cycle | Electrolyte | Anode/Current |
|---|---|---|---|---|---|---|---|---|---|---|
| | 12B | 12A | | One-side film | | | | characteristics | solution | collector foil |
| | electrode | electrode | 12B one-side | thickness of | | | | (charge | permeability | sealing |
| | density A | density B | film thickness | anode mix | Conducting | | | retention | evaluation | evaluation |
| | (g/cm³) | (g/cm³) | (μm) | layer (μm) | agent | Shape | Taper | rate %) | results | results |
| Example 1 | 1.8 | 1.4 | 19 | 57 | No | Line | No | 93 | Good | Good |
| Example 2 | 1.7 | 1.2 | 15 | 60 | No | Dot | — | 91 | Good | Good |
| Example 3 | 1.9 | 1.4 | 20 | 57 | No | Line | Yes | 90 | Good | Good |
| Example 4 | 1.7 | 1.4 | 30 | 57 | Yes | Line | No | 88 | Good | Good |
| Comparative | 2 | — | — | 57 | No | — | — | 51 | No good | Good |
| example 1 | | | | | | | | | | |
| Comparative | — | 0.9 | — | 57 | No | — | — | 64 | Good | No good |
| example 2 | | | | | | | | | | |

The charge retention rate figures shown in the table are the values when 100 was set as the discharge capacitance prior to the cycle test for each of the wound type lithium-ion rechargeable batteries.

In results from the cycle test as shown in Table 1, the charge retention rate after 500 cycles had elapsed for the lithium-ion rechargeable batteries of the examples 1 through 4 was 88 to 93%. In the lithium-ion rechargeable batteries of the comparative examples 1 and 2 the charge retention rate after 500 cycles had elapsed was 51 to 64%.

The permeability of the electrolyte solution was evaluated using electrodes from the same lot utilized in the wound type lithium-ion rechargeable batteries. In the evaluation method, the residual droplet amount on the electrode mix layer upon which electrolyte solution was dripped was measured.

In permeability measurement results, the electrode where the low density anode mix layer 12A was formed had faster permeability for the electrolyte solution than the high density anode mix layer 123. The structure in which the low density anode mix layer 12A of the present invention was formed can therefore improve the permeability.

The sealing of the anode mix layer 12 and the anode current collector 11 was also evaluated using the above electrodes of the examples 1 through 4 and the comparative examples 1 and 2. In the measurement results, the electrodes for the examples 1 through 4 and the comparative example 1 in which the high density anode mix layer 123 was formed over the current collector 11 all had high peeling strength, and the sealing between the anode mix layer and the copper current collector was excellent. Therefore, the structure in which the high density anode mix layer is formed over the current collector is effective in improving the electrode sealing and reinforcing the wind piece.

In the lithium-ion rechargeable battery of the examples 1 through 4, the structure comprised of the low density anode mix layer 12A and the high density anode mix layer 12B had improved electrolyte solution permeability and improved binding characteristics in the respective active materials by utilizing a structure in which the low density anode mix layer 12A covers the upper and side surfaces of the high density anode mix layer 12B formed in a dot or a line shape, and consequently a vast improvement was conclusively verified in the charge retention rate after the rechargeable battery cycles.

The present invention is not limited to the above described examples 1 through 4 and may include all manner of modifications. The examples 1 and 2 of the present invention were for instance described in detail in order to make the invention easy to understand; however, the present invention is not necessarily limited to always including all of the described structures. Moreover, a portion of the structure of an example can be substituted into the structure of another example. The structure of an example can also for instance be added to a particular example. Further, portions of the structure of each of the examples 1 through 4 can also be added, deleted, or substituted with portions of other structures.

1. An anode for a lithium-ion rechargeable battery including an anode mix layer comprising:
a high density anode mix layer formed over an anode current collector; and
a low density anode mix layer formed over the high density anode mix layer,
wherein the electrode density of the high density anode mix layer is larger than the electrode density of the low density anode mix layer, and the upper surface and the side surfaces of the high density anode mix layer are covered by the low density anode mix layer.

2. The anode for a lithium-ion rechargeable battery according to claim 1,
wherein the film thickness of the high density anode mix layer is 50% or less than the film thickness of anode mix layer.

3. The anode for a lithium-ion rechargeable battery according to claim 1,
wherein the high density anode mix layer is formed in a line shape over the anode current collector.

4. The anode for a lithium-ion rechargeable battery according to claim 3,
wherein the composition of the high density anode mix layer is the same composition as the low density anode mix layer.

5. The anode for a lithium-ion rechargeable battery according to claim 4,
wherein the percentage occupied by the width of the high density anode mix layer is 60% or less than the width of the anode mix layer.

6. The anode for a lithium-ion rechargeable battery according to claim 4,
wherein a conducting agent is added to the high density anode mix layer, and
the conducting agent is not added to the low density anode mix layer.

7. The anode for a lithium-ion rechargeable battery according to claim 6,
wherein the anode current collector and the anode mix layer are wound, and
the high density anode mix layer is formed in a line shape, and is perpendicular relative to the wound direction of the anode for the lithium-ion rechargeable battery.

8. The anode for a lithium-ion rechargeable battery according to claim 6,
wherein the anode current collector and the anode mix layer are wound, and
the high density anode mix layer is formed in a line shape parallel to the wound direction of the anode for the lithium-ion rechargeable battery, and
the high density anode mix layer is formed only over the edge along the width direction of the anode mix layer.

9. The lithium-ion rechargeable battery comprising:
an anode for a lithium-ion rechargeable battery according to claim 8;
a cathode for a lithium-ion rechargeable battery; and
an organic electrolyte solution in which the cathode for a lithium-ion rechargeable battery and the anode for a lithium-ion rechargeable battery are submerged.

10. A manufacturing method for an anode for a lithium-ion rechargeable battery including an anode mix layer comprising a high density anode mix layer formed over the anode current collector, and a low density anode mix layer formed over the high density anode mix layer,
wherein the electrode density of the high density anode mix layer is larger than the electrode density of the low density anode mix layer,
the upper surface and the side surfaces of the high density anode mix layer are covered by the low density anode mix layer, and
the method comprising:
forming a high density anode mix layer over the anode current collector; and forming a low density anode mix layer so as to cover the upper and side surfaces of the high density anode mix layer after forming the high density anode mix layer.
